(19) United States
(12) Patent Application Publication
(10) Pub. No.: US 2013/0128620 A1
(43) Pub. Date: May 23, 2013

(54) VEHICULAR LAMP

(71) Applicant: KOITO MANUFACTURING CO., LTD., Tokyo (JP)

(72) Inventors: Mamoru KOSUGE, Shizuoka-shi (JP); Asami NAKADA, Shizuoka-shi (JP)

(73) Assignee: KOITO MANUFACTURING CO., LTD., Tokyo (JP)

(21) Appl. No.: 13/676,190

(22) Filed: Nov. 14, 2012

(30) Foreign Application Priority Data
Nov. 21, 2011 (JP) 2011-253652

(51) Int. Cl. F21V 8/00

(52) U.S. Cl. CPC G02B 6/0035
USPC 362/623

(57) ABSTRACT

Provided is a vehicular lamp that includes a light source and a light guide that guides a light from the light source in the inside thereof. The light guide is formed by an injection molding, and a plurality of reflective elements spaced from each other are formed in the rear surface of the light guide. Each of the reflective elements is formed to protrude from the rear surface of the light guide toward the rear side, and the inner surface of each of the reflective elements internally reflects the light from the light source toward the front surface of the light guide.

### CROSS-REFERENCE TO RELATED APPLICATIONS

This application is based on and claims priority from Japanese Patent Application No. 2011-253652, filed on Nov. 21, 2011, with the Japanese Patent Office, the disclosure of which is incorporated herein in its entirety by reference.

### TECHNICAL FIELD

The present disclosure relates to a vehicular lamp in which a manufacturing cost of an injection molding mold is decreased and light utilization efficiency is improved.

### BACKGROUND

A type of a vehicular lamp utilizes a plate-type light guide that reflects the light from a light source at a plurality of reflective elements within the plate-type light guide to emit the light in a planar shape. Japanese Patent Application Laid-Open No. 2009-218076 discloses a vehicular lamp equipped with a plate-type light guide having a plurality of fine concave cone-shaped reflective elements on a rear surface of the plate-type light guide. The light guided within the plate-type light guide is internally reflected between an inner side of the rear surface except for the portions where the reflective elements are formed and an inner side of a front surface, and then is internally reflected by each of the concave cone-shaped reflective elements, thereby emitting light by the plurality of reflective elements.

### SUMMARY

The plurality of concave cone-shaped reflective elements are formed using a mold including a plurality of fine convex cone-shaped protrusions. When the rear surface of the plate-type light guide except for portions where the reflective elements are formed (“the rear surface”) is formed with a rough surface, the rear surface irregularly reflects a portion of the incident light instead of reflecting the incident light internally, thereby causing a problem. First of all, a portion of the light irregularly reflected in the rear surface leaks toward the rear side of the plate-type light guide, and thus, the light utilization efficiency in the plate-type light guide is decreased.

In the plate-type light guide, light is emitted by the reflective elements to realize a predetermined light distribution. However, in a plate-type light guide having a rough rear surface, light may be unevenly emitted by the irregular reflection through the surface portion on which a reflective element is not formed, and therefore, there is a problem in that the plate-type light guide is not seen as a predetermined appearance color. In other words, an external light such as, for example, the sunlight incident through the outer cover is irregularly reflected in the rear surface of the plate-type light guide at the time of turning-OFF, and the light from the light source is irregularly reflected in the rear surface of the plate-type light guide at the time of turning-ON. As a result, a problem occurs in which light is irregularly emitted through the rear surface of the plate-type light guide except for the portions where the reflective elements are formed, and thus, the light guide as a whole is not seen as a predetermined appearance color.

For example, there is a problem that, when the outer cover is colorless and transparent, in the plate-type light guide at the time of turning-OFF, a color similar to a white color based on the color of the outer cover may be seen by irregularly reflecting the external light such as, for example, the sunlight in the rear surface (when the outer cover is red, it may be seen as a color similar to red), instead of a predetermined appearance color as a whole. Even in the plate-type light guide at the time of turning-ON, there is a problem that an appearance color similar to the color of the outer cover may be seen based on the irregular reflection of the light from the light source and the color of the outer cover, instead of the predetermined appearance color as a whole, and thus, the quality of an appearance (beauty) is decreased.

As described above, there is problem in that the irregular reflection in the rear surface of the plate-type light guide may make the plate-type light guide to be seen as an appearance color other than a predetermined appearance color making the control of the light distribution difficult. Therefore, in a molding of the plate-type light guide, the rear surface of the molding surface needs to be polished into a plane and a mirror surface by, for example, a manual operation using an abrasive agent and an abrasive fabric. Further, the mirror-like finishing of the rear surface prevents the irregular reflection of the light and has advantages in which the appearance color of the plate-type light guide may be seen as a predetermined color at the time of turning-OFF and a predetermined light distribution may be obtained at the time of turning-ON.

Meanwhile, the portion of the mold where the rear surface is formed may be strongly pressed and polished with the abrasive fabric by a manual operation. A fine protrusion of the mold that forms a reflective element is polished and may be slightly deformed by the manual operation with a pressure. The deformed protrusion in the mold has a problem in that the concave cone-shaped reflective element may not be formed in the predetermined shape, and the fine reflective element slightly deformed from the predetermined shape does not reflect light toward a predetermined direction, thereby decreasing the light utilization efficiency. Therefore, in the mold that forms a concave shape fine reflective element, the polishing may be performed avoiding the fine protrusions.

However, when the pitch of the protrusions of the mold is narrowed, it becomes difficult to polish the fine protrusions without damages. Therefore, in a mold that forms a plurality of fine concave cone-shaped reflective elements, the forming surface of the mold except for the protrusions may be polished carefully which will take a time and a cost, or the pitch of the protrusions may be widened so that the protrusions are not damaged by mistake when the forming surface is polished. However, if the pitch of the protrusions of the mold is widened, there occurs a limit in improving the reflective light utilization efficiency where a plurality of reflective elements are provided in the plate-type light guide.

Further, a fine protrusion provided in the mold to form a concave reflective element is disposed in such a way that blocks a flow path of a resin for molding. The front end of the flowing resin is once branched into left and right by the protrusion of the mold, and then does not return to the surface of flow downstream of the protrusion and joins at the downstream of the flow path. In this case, in the mold that forms the plate-type light guide of Japanese Patent Application Laid-Open No. 2009-218076, a gap is formed in the flow path of the resin, and a weld line is formed by the gap across the downstream from the reflective element of the plate-type light guide. The weld line is seen, and thus, the appearance of the plate-type light guide is deteriorated.

The weld line formed in the plate-type light guide becomes a problem in that the weld line scatters (irregularly reflects) or adsorbs the light guided within the plate-type light guide to lower the light utilization efficiency. The irregular reflection caused by the weld line makes the plate-type light guide to be seen as an appearance color other than a predetermined appearance color as a whole as in the rear surface of the plate-type light guide which is not formed in a mirror surface, thereby deteriorating the appearance of the plate-type light guide.

In view of the problems described above, a vehicular lamp is provided in the present disclosure in which the manufacturing cost of the injection molding mold of the light guide is decreased, and the light utilization efficiency in the light guide is improved. Further, the control of the light emitting in the light guide is facilitated and the appearance of the light guide is also improved in the vehicular lamp of the present disclosure.

A vehicular lamp according to the first aspect of the present disclosure is equipped with a light source and a plate-type light guide where the light from the light source is guided therein. The light guide is formed by an injection molding, and a plurality of reflective elements spaced from each other are formed in the rear surface of the light guide. The reflective elements formed to protrude from the rear surface of the light guide toward the rear side and internally reflect the light from the light source toward the front surface of the light guide.

(Effects) In the vehicular lamp of the first aspect, the plurality of reflective elements provided in the plate-type light guide are formed in a convex shape, and thus, the portions of the mold where the reflective elements are formed become a plurality of concave shapes (a concave portion). In the mold, the portions that form the reflective elements are formed sink as compared to the portion that forms the rear surface of the light guide (except for the portions where the reflective element are formed, hereinafter the same). And thus, even though the pitch of the portions that form the plurality of reflective elements is narrowed, only the portions that form the rear surface of the light guide may be polished in a mirror surface without cracking the portions of the mold that form the reflective elements. As a result, in the vehicular lamp of the first aspect, a plurality of reflective elements may be easily formed in the light guide without collapsing the shape, and the rear surface of the light guide may be easily formed in a mirror surface.

In the rear surface of the light guide formed in a mirror surface, the internal reflection of the light is promoted to prevent the irregular reflection, and thus, a portion of light does not leak toward the rear side of the light guide, and the irregular emitting of light is prohibited from the rear surface except for portions where the reflective elements are formed. The appearance color of the light guide at the time of turning-ON and OFF may be seen as the predetermined color based on the emitting of light from the reflective elements while the irregular reflection is prevented at the rear surface, and thus, a predetermined emitting of light is realized in the light guide. The concave shape of the light guide that becomes a reflective element may be machine processed after the rear surface of the light guide is finished until the rear surface of the light guide becomes a mirror surface.

In the vehicular lamp of the first aspect, the reflective element is not formed to be sunk toward an inner-side of the light guide, and thus, the light within the light guide is not blocked by the reflective elements and can be easily guided into the surface direction of the light guide. The portions of the mold that molds the light guide of the first aspect where the reflective elements of the light guide are formed are formed in the inner-side of the mold, that is, the out-side of the flow path of the resin, which is different from the conventional mold, and thus, the portions that form the reflective elements do not block the flow path of the resin for molding. As a result, the resin that flows within the mold is easily filled in portions that form the reflective elements after the resin is filled in the flow path within the mold. And thus, the weld line formed by joining of the flow front-ends of the separated resin is hardly formed near the reflective elements. By the decrease of the weld line in the light guide, the irregular reflection and the absorption of the light caused by the weld line hardly occur within the light guide.

In a vehicular lamp according to the second aspect of the present disclosure, with respect to a virtual cross-section configured by cutting one of the reflective elements by a plane in which a normal line thereof is an orthogonal direction perpendicular to the plate surface of the light guide, the reflective elements are formed such that the cross-sectional area of the virtual cross-section becomes smaller as much as possible as the cutting position goes farther rearward.

(Effects) In the vehicular lamp of the second aspect, the light incident to the inside of the light guide is reflected by a reflective element to emit the light toward the front side of the light guide. The reflective element has a convex shape in which the end thereof is slenderized toward the rear side of the light guide.

In a vehicular lamp according to the third aspect of the present disclosure, each of the reflective elements has a cone shape in which the peak thereof is round as an arc, a truncated cone shape, or a dome shape.

(Effects) In the vehicular lamp of the third aspect, the light incident to the inside of the light guide is reflected within the reflective element several times, and then emitted toward the front side of the light guide. The light emitted toward the front side of the light guide is reflected in the inside of the reflective element several times, and thus, emitted with a more acute angle with respect to the front and rear direction of the light guide.

In a vehicular lamp according to the fourth aspect of the present disclosure, the front surface of the light guide has a curved shape along with an outer cover of the vehicular lamp.

(Effects) In the vehicular lamp of the fourth aspect, a sense of unity is generated between the shape of the front surface of the light guide and the curved shape of the outer cover.

According to the vehicular lamp of the first aspect, when the plurality of reflective elements are provided, the trouble to polish the mold is reduced, and thus the manufacturing cost may be decreased. The light leakage toward the rear side of the light guide and the irregular emitting of light at the rear surface of the light guide except for the portions where the reflective elements are formed are prevented, and the occurrence of the weld line is decreased. As a result, the light utilization efficiency in the light guide may be improved. The light guide is seen as a predetermined appearance color at the time of turning-ON and OFF, and the appearance of the light guide may be improved at the time of turning-ON and OFF. Further, the degree of freedom of mold machining is improved, and the pitch of the reflective elements is narrowed to form a plurality of reflective elements without a shape collapse in the light guide. As a result, the light is easily controlled and the light utilization efficiency may be improved.

Further, according to the vehicular lamp of the first aspect, the light within the light guide is easily guided to the surface direction of the light guide, and thus, the light may be readily emitted evenly from the reflective elements of the light guide. Further, according to the vehicular lamp of the first aspect, the weld line caused by forming of the reflective elements is hardly formed in the light guide, and thus, the weld line itself is hardly seen thereby improving the appearance of the light guide.

According to the vehicular lamp of the second aspect, the light distribution control within the light guide is easily performed, and thus, the light utilization efficiency may be further improved.

According to the vehicular lamp of the third aspect, the light is emitted toward the front side of the light guide with more acute angle with respect to the front and rear direction of the light guide, and thus, the light utilization efficiency may be improved. Further, since the emitting direction of the light is easily controlled, the degree of freedom of the arrangement of the light source with respect to the light guide may be improved.

According to the vehicular lamp of the fourth aspect, the appearance of the vehicular lamp may be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a horizontal cross-sectional view illustrating a vehicular lamp according to the present disclosure.

FIG. 2A is a front view illustrating a light guide of a vehicular lamp according to an exemplary embodiment of the present disclosure.

FIG. 2B is an enlarged perspective view illustrating a plurality of reflective elements provided in a rear surface of a light guiding part of the light guide.

FIG. 3A is a cross-sectional view taken along line I-I of FIG. 2A.

FIG. 3B is an enlarged cross-sectional view of FIG. 3A, which describes an optical path in the light guiding part.

FIG. 3C is an enlarged cross-sectional view illustrating a first modified example of the reflective element.

FIG. 3D is an enlarged cross-sectional view illustrating a second modified example of the reflective element.

FIG. 4A is a cross-sectional view taken along line II-II of FIG. 3B.

FIG. 4B is a cross-sectional view illustrating a third modified example of the reflective element.

FIG. 4C is a cross-sectional view illustrating a fourth modified example of the reflective element.

FIG. 4D is a cross-sectional view illustrating a fifth modified example of the reflective element.

FIG. 4E is a cross-sectional view illustrating a sixth modified example of the reflective element.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

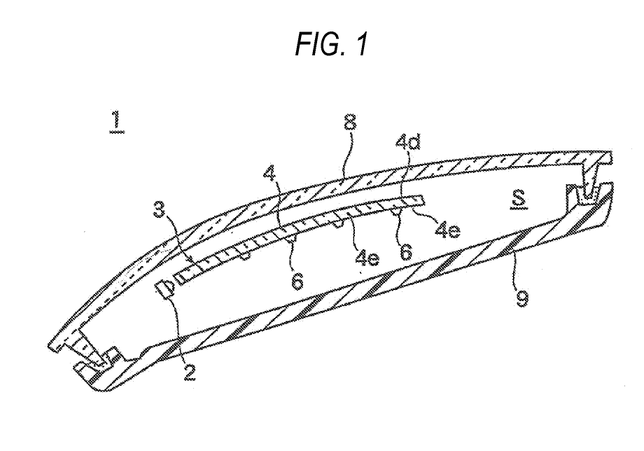

Referring to FIGS. 1 to 4, descriptions will be made for exemplary embodiments of a vehicular lamp according to the present disclosure. A vehicular lamp 1 in each of the exemplary embodiments includes a light source 2, a light guide 3, an outer cover 8 and a lamp body 9. The light source 2 is formed as a unit including a light emitting device 2a. For example, a red LED may be adopted for a STOP lamp, but the color of the LED is not limited to the red color.

The light guide 3 is constituted by a light guiding part 4 and a light introducing part 5, and formed with an injection molding using a raw material such as, for example, a transparent or semi-transparent resin. The outer cover 8 is made of, for example, a transparent or semi-transparent resin to have a curved shape, and is integrally formed with the lamp body 9 made of the resin. The light source 2 and the light guide 3 are disposed within a lamp chamber S which is formed in the inner side of the outer cover 8 and the lamp body 9. The light guiding part 4 is formed so that a front surface 4d and a rear surface 4e thereof are substantially in parallel to each other, and the front surface 4d of the light guiding part 4 (light guide 3) has a curved shape along the outer cover 8 as illustrated in FIG. 1.

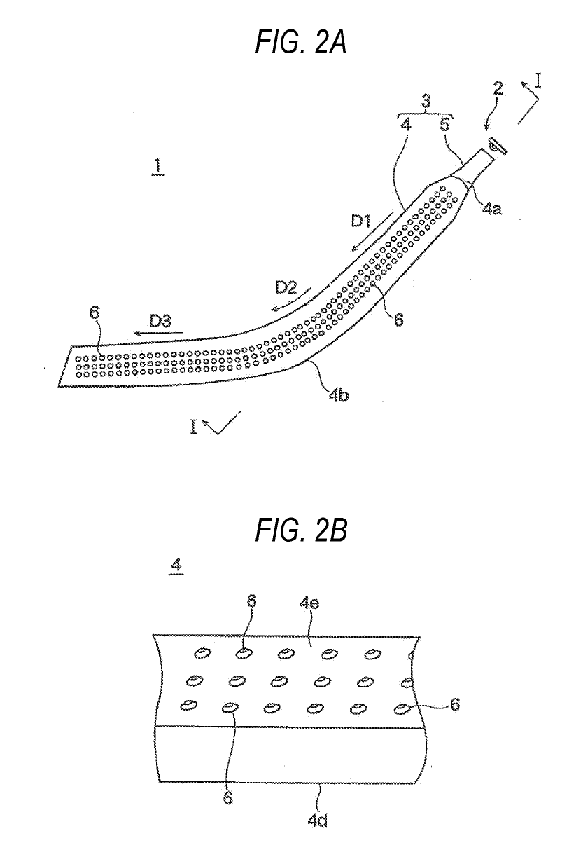

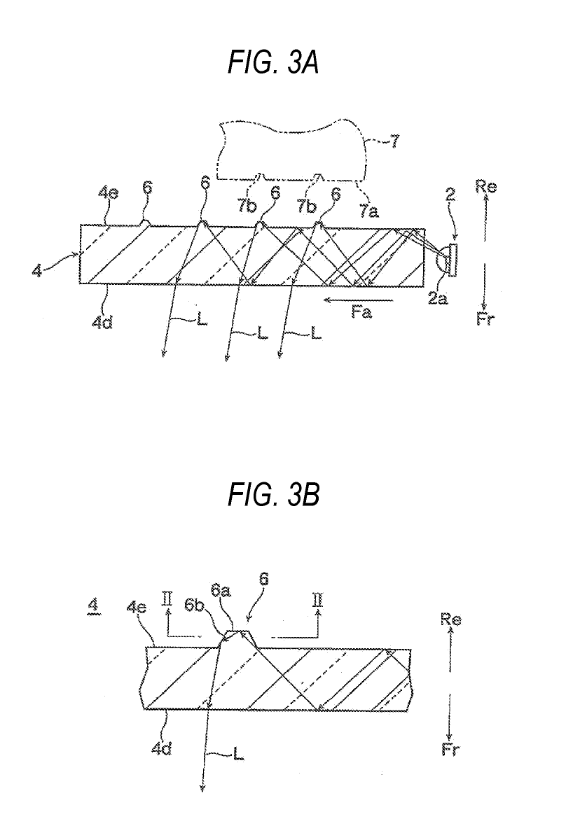

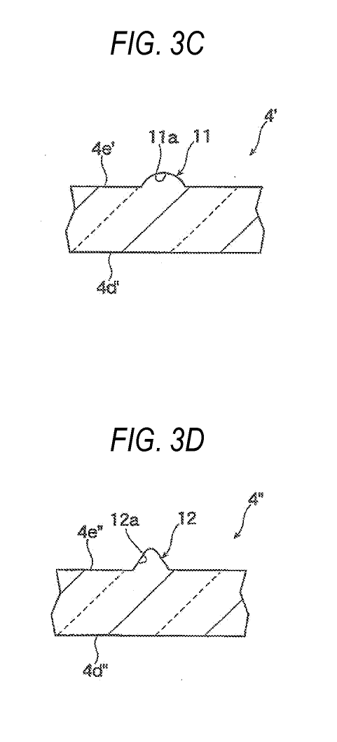

As illustrated in FIG. 2A, the light guiding part 4 is formed as a plate shape. The light introducing part 5 has a cylindrical shape, and is integrally formed with a base-end portion 4a of the light guiding part 4 which is a plate shape. The light guiding part 4 when viewed from the front, as illustrated in FIG. 2A, has a shape in which the light guiding part 4 is extendedly formed in a straight form, and a part thereof is curved through a curved portion 4b. Hereinafter, descriptions will be made with an assumption that the thickness direction of the light guiding part 4 (the light guide 3) is a front and rear direction, the direction of the reference symbol “Fr” is the front side of the light guiding part 4, the direction of the reference symbol “Re” is the rear side of the light guiding part 4, and the direction of the reference symbol “Fa” is a direction following the surface of the light guiding part 4 (“surface direction”) as illustrated in FIGS. 3A and 3B.

The rear surface 4e of the light guiding part 4 is provided with a plurality of reflective elements 6 in a predetermined interval. Each of the reflective elements 6 in the present exemplary embodiment is formed to have a truncated cone shape as illustrated in FIG. 2B, and protrude from the rear surface 4e of the light guiding part 4 toward the rear side.

A virtual line in FIG. 3A illustrates a mold 7 to form a plurality reflective elements 6. The mold 7 is provided with a plurality of concave portions 7b in a concave truncated cone shape to form the reflective elements 6 having a convex truncated cone shape. Each of the concave portions 7b is formed by being sunk toward the rear side from a front surface 7a of the mold 7, and thus, only the front surface 7a except for the concave portion 7b may be easily polished to reduce the manufacturing cost of the mold 7. The rear surface 4e of the light guiding part 4 is molded using the front surface 7a of the mold 7 as a molding surface, in which the rear surface 4e is formed in a mirror-surface by polishing the front surface 7a, thereby reducing the surface roughness of the front surface 7a. As a result, the light reflected at the inner side of the rear surface 4e formed in a mirror-surface and to be emitted toward the front side from the front surface 4d of the light guiding part 4 is not irregularly reflected by the rear surface 4e. And thus, the light utilization efficiency may be prevented from being decreased caused by the light leakage toward the rear side of the light guiding part 4. Further, in the light guiding part 4, the rear surface 4e does not emit the light unevenly and carelessly by the prevention of the irregular reflection of the rear surface 4e. As a result, even though an external light such as, for example, the sunlight at the time of turning-OFF or the light from the light source at the time of turning-ON is received in the rear surface 4e of the guiding part 4, the appearance color of the light guiding part 4 may be seen as a predetermined color based on the light emitting from the reflective elements 6 rather than the color similar to the color of the outer cover. Therefore, a predetermined light emitting may be realized in the light guiding part 4 to improve the appearance.

Next, the optical path of the light guided inside the light guide 3 will be described with respect to FIGS. 2 and 3. The light emitted from the light emitting device 2a of the light source 2 is incident to the light guiding part 4 through the light introducing part 5. The light incident into the light guiding part 4 is guided in a direction where the light guiding part 4 extends from the base-end portion 4a (a direction of reference symbols D1 to D3) in the surface direction Fa, as illustrated in FIGS. 2A and 3A.

Light L incident into the light guiding part 4 is reflected several times between the front surface 4d and the rear surface 4e in the front and rear direction of the light guiding part 4 as illustrated in FIG. 3A, and then incident into a reflective element 6 formed in a convex truncated cone shape. As illustrated in FIG. 3B, the light L incident into the reflective element 6 is reflected from an inner side of a bottom surface 6a toward a lateral surface 6b, and then, reflected from an inner side of the lateral surface 6b toward the front surface 4d of the light guiding part 4. Subsequently, the light L is emitted from the front surface 4d toward the front side of the light guiding part 4. The light incident into the reflective element 6 may be emitted with an acute angle with respect to the front and rear direction of the light guiding part 4 by being reflected two times or more in the inside of the reflective element 6, and thus, may be emitted toward the front side of the light guiding part 4 without a waste. As a result, the light utilization efficiency may be improved in the light guide 3 because the emitting direction of the light is easily controlled. Further, in the vehicular lamp 1 of the present exemplary embodiment, the light distribution is easily controlled to improve the degree of freedom of the arrangement of the light source 2 with respect to the light guide 3.

The reflective element 6 in the present exemplary embodiment is provided to protrude toward the rear side of the light guiding part 4 instead of being sunken from the rear surface of the light guide toward the inner side as in Japanese Patent Application Laid-Open No. 2009-218076. Accordingly, the light incident into the light guiding part 4 is easily diffused in the surface direction Fa while the reflective elements 6 are not acting as an obstacle, and thus, in the present exemplary embodiment, the light may easily reach to a reflective element 6 disposed further away from the light source 2. In the light guide 3 of the present exemplary embodiment, the reflective elements 6 are formed by protruding toward the rear side of the light guiding part 4. The portions 7b that form the reflective elements are formed in the inner side of the mold 7, that is, in the outer side of the flow path of the resin within the mold 7 which are oppositely disposed unlike in the related art, and the portions 7b do not block the flow path of the resin flowing with the mold that forms the plate-type light guide in Japanese Patent Application Laid-Open No. 2009-218076. As a result, the resin that flows within the mold is easily filled into the flow path within the mold that forms the portion other than the reflective elements 6 of the light guiding part 4, and then, is filled into the concave portions 7b which become the portions that form the reflective elements. As a result, a weld line caused by re-joining of the flow front ends of the resin which are divided as in the related art is hardly formed near the reflective elements 6 of the light guiding part 4. Accordingly, in the light guiding part 4 in the present exemplary embodiment, there is no problem of the appearance caused by the weld line to be seen.

In the light guiding part 4 at the time of turning-OFF, an external light such as, for example, the sunlight may be incident into the lamp chamber S through the outer cover 8. When the rear surface 4e is not polished into a mirror surface and a large weld line is formed in the rear surface 4e, the external light is irregularly reflected by the rear surface being formed roughly or by the weld line. When the outer cover 8 is colorless and transparent, the external light may be irregularly emitted from the rear surface of the light guiding part 4 having a rough surface or from the weld line, and the light guiding part 4 is seen as a color similar to white as a whole (if the outer cover 8 is red, a color similar to red), instead of the predetermined appearance color. Further, when an irregular emitting caused by the irregular reflection from the rear surface or the weld line occurs in the light guiding part 4 at the time of turning-ON, the light guiding part 4 is seen as a color similar to red as a whole based on the red color of the light source 2 and the transparent color of the outer cover 8, instead of the predetermined appearance color. However, in the light guiding part 4 of the present exemplary embodiment, the rear surface 4e is formed into a mirror-surface and the generation of the weld line is reduced, and thus, the light guiding part 4 is seen as a predetermined appearance color. In each of the exemplary embodiments of the present disclosure, the appearance of the light guiding part 4 is improved.

Next, a second modified example and a third modified example will be described with respect to FIGS. 3C and 3D. FIGS. 3C and 3D are cross-sectional views of the reflective elements 11, 12, in the front and rear direction of the light guiding part (light guide), respectively, as in FIGS. 3A and 3B. The reflective element 11 formed to protrude toward the rear side of the rear surface 4e′ of the light guiding part 4′ as illustrated in FIG. 3C is formed in a dome shape, and the reflective element 12 formed to protrude toward the rear side of the rear surface 4e″ of the light guiding part 4″ as illustrated in FIG. 3D is formed in a shape where the peak of a cone is rounded as an arc. Each of the lights incident to the reflective elements 11, 12 is reflected two or more times by the corresponding inner surfaces 11a, 12a, and then, emitted toward the front side from the front surfaces 4d′, 4d″ of the light guiding parts 4′, 4″ as in the reflective element 6 of FIG. 3B.

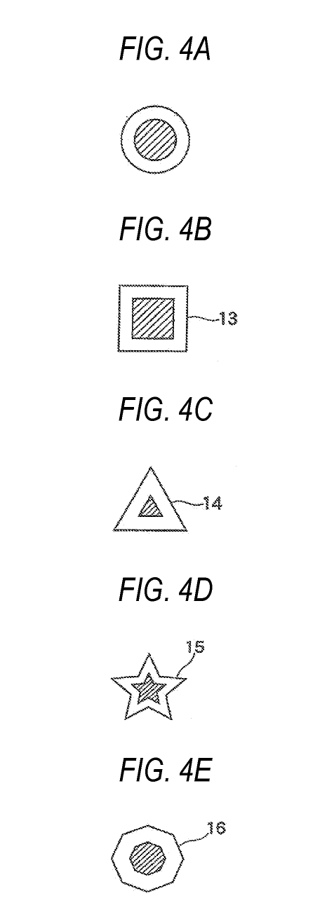

FIG. 4A is a view where the reflective element 6 is cut along a plane in which a normal line thereof is an orthogonal direction perpendicular to the plate surface of the light guiding part 4 (the light guide 3), that is, a cross-sectional view taken along line II-II of FIG. 3B, and FIGS. 4B to 4E illustrate a third modified example to a sixth modified example of the reflective element in which the end thereof is slenderized toward the rear side of the light guiding part, respectively.

The reflective element 6 illustrated in FIG. 3B (the same as in the reflective elements 11 and 12 in FIGS. 3C and 3D) is formed so that a cross-section in which the normal line thereof is an orthogonal direction perpendicular to the plate surface of the light guiding part 4 is formed in a circle, and the circular cross-section has a shape which is gradually decreased toward the rear side of the light guiding part 4.

Meanwhile, in the reflective elements 13 to 16 in FIGS. 4B to 4E, each of the cross-section shapes in which the normal line thereof is an orthogonal direction perpendicular to the plate surface of the light guiding part is different from that of the reflective element 6. The reflective element 13 in FIG. 4B is formed such that a cross-section in which the normal line thereof is an orthogonal direction perpendicular to the plate surface of the light guide is a quadrangle, not a circle, the reflective element 14 in FIG. 4C is formed such that a cross-section in which the normal line thereof is an orthogonal direction perpendicular to the plate surface of the light guiding part is a triangle, the reflective element 15 in FIG. 4D is formed such that a cross-section in which the normal line thereof is an orthogonal direction perpendicular to the plate surface of the light guiding part is a star, and the reflective element 16 in FIG. 4E is formed such that a cross-section in which the normal line thereof is an orthogonal direction perpendicular to the plate surface of the light guiding part is an octagon. Each of the cross-sections in the reflective elements 13 to 16 in which the normal line thereof is an orthogonal direction perpendicular to the plate surface of the light guiding part is gradually decreased toward the rear side of the light guiding part as in the reflective element 6.

Each of the cross-section shapes in the reflective elements 6, 11, 12 in which the normal line thereof is an orthogonal direction perpendicular to the plate surface of the light guiding part is not limited to a circle, but may be an ellipse or an elongate circle, as long as it is a closed curve shape.

In the reflective elements 13 to 16, the cross-section cut-off in the orthogonal direction perpendicular to the plate surface of the light guiding part (light guide) may be a trapezoid shape as in the reflective element 6 as illustrated in FIG. 3B, or may be an arc or a substantially triangle shape of which the peak is an arc as in the reflective elements 11 and 12 as illustrated in FIGS. 3C and 3D.

As described above, the shape of the reflective element may be considered in various shapes as long as the end is slenderized toward the rear side of the light guiding part.

Even though the light guide 3 in each of the present exemplary embodiments as illustrated in FIGS. 1, 2A, 3A and 3B, has the same plate thickness in the front and rear direction, the light guide 3 may be formed such that the plate thickness becomes smaller in the front and rear direction as the distance from the light source 2 becomes farther with reference to a place where light is incident from the light source 2. Even though the amount of light guided within the light guide becomes smaller as the distance from the light source becomes closer, the light emitted from the front surface of the plate-type light guide may be uniform in the plate-type light guide regardless of the positions by forming the light guide such that the thickness of the plate becomes smaller as the distance from the light source becomes farther.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A vehicular lamp comprising:
a light source; and
a plate-type light guide that guides a light from the light source in the inside thereof,
wherein the light guide is formed by an injection molding,
a plurality of reflective elements are provided on a rear surface of the light guide to be spaced from each other,
the reflective elements are formed to protrude from the rear surface of the light guide toward the rear side, and
the reflective elements internally reflect the light from the light source toward a front surface of the light guide.

2. The vehicular lamp of claim 1, wherein assuming that a virtual cross-section is configured by cutting any of the reflective elements with a plane in which a normal line thereof corresponds to an orthogonal direction perpendicular to the plate surface of the light guide, the reflective elements are formed such that the cross-sectional area of the virtual cross-section becomes smaller as the cutting position becomes farther rearward.

3. The vehicular lamp of claim 1, wherein each of the reflective elements is formed in a cone shape with a peak rounded in a circular arc shape, a truncated cone shape, or a dome shape.

4. The vehicular lamp of claim 2, wherein each of the reflective elements is formed in a cone shape with a peak rounded in a circular arc shape, a truncated cone shape, or a dome shape.

5. The vehicular lamp of claim 1, wherein the front surface of the plate-type light guide is curved along an outer cover of the vehicular lamp.

6. The vehicular lamp of claim 2, wherein the front surface of the plate-type light guide is curved along an outer cover of the vehicular lamp.

7. The vehicular lamp of claim 3, wherein the front surface of the plate-type light guide is curved along an outer cover of the vehicular lamp.

8. The vehicular lamp of claim 4, wherein the front surface of the plate-type light guide is curved along an outer cover of the vehicular lamp.
